(19) United States
(12) Patent Application Publication
(10) Pub. No.: US 2012/0163002 A1
(43) Pub. Date: Jun. 28, 2012

(54) DISCHARGE LAMP LIGHTING DEVICE

(75) Inventors: Shohei Yanagidu, Shizuoka (JP); Masayasu Ito, Shizuoka (JP); Naoki Sugiura, Shizuoka (JP)

(73) Assignee: KOITO MANUFACTURING CO., LTD., Tokyo (JP)

(21) Appl. No.: 13/329,467

(22) Filed: Dec. 19, 2011

(30) Foreign Application Priority Data
Dec. 28, 2010 (JP) 2010-292568

(51) Int. Cl. F21V 21/00

(52) U.S. Cl. 362/382

(57) ABSTRACT

A discharge lamp lighting device includes a discharge lamp, a circuit module configured to supply a voltage to the discharge lamp so as to turn on the discharge lamp, a case member configured to accommodate the circuit module, and a connecting member, in which the discharge lamp is mounted, configured to connect the discharge lamp to the circuit module. The circuit module includes a substrate. The connecting member is integrated with the substrate of the circuit module.

### CROSS-REFERENCE TO RELATED APPLICATION(S)

The present application claims the benefit of priority of Japanese Patent Application No. 2010-292568, filed on Dec. 28, 2010. The disclosure of this application is incorporated herein by reference.

### BACKGROUND

1. Technical Field

The present invention relates to a lighting device for a discharge lamp of a motor vehicle or the like and, more particularly, to a fixing construction of a discharge lamp within a bulb-integrated ballast system.

2. Related Art

As a lighting device for a discharge lamp, which is used as a headlamp of a vehicle, conventionally, there have been put to practical use a lighting device in which a high voltage generating module (a starter) is incorporated in a bulb socket and a lighting device with which a discharge lamp, a starter, and a case are integrated. In them, there is known a lighting device in which a supply voltage converting module and a control circuit (a ballast system) are added to such a starter and the starter and the ballast system are incorporated in a bulb socket or integrated with a discharge lamp (for example, Patent Literature 1).

Normally, in a discharge lamp lighting device in which a ballast system and a starter are incorporated or integrated into a bulb socket, in order to suppress noise, the bulb socket needs to be covered with a metallic cover partially or fully along the circumference thereof.

In addition, in a discharge lamp lighting device with a bulb-integrated ballast system, a substrate on which electronic parts are mounted is covered with a resin cover and a bulb socket is fixed to the resin cover.

### SUMMARY

However, as has been described above, when the metallic cover is mounted on the resin cover, which eventually results in a double-cover construction, and it becomes difficult to improve the workability and the assembling properties of the discharge lamp lighting device.

In addition, when adopting the double-cover construction, a layer of air is defined between the metallic cover and the resin cover, and it becomes difficult to improve the heat radiating properties.

One or more embodiments of the present invention provides a discharge lamp lighting device which can improve the workability and the assembling properties and which can realize an improvement in heat radiating properties.

A discharge lamp lighting device according to one or more embodiments of the present invention includes:

a discharge lamp;

a circuit module configured to supply a voltage to the discharge lamp so as to turn on the discharge lamp, the circuit module including a substrate;

a case member configured to accommodate the circuit module; and

a connecting member, in which the discharge lamp is mounted, configured to connect the discharge lamp to the circuit module, wherein

the connecting member is integrated with the substrate of the circuit module.

According to the discharge lamp lighting device with the above-mentioned structure, the connecting member is formed integrally with the second substrate which makes up part of the circuit module. Therefore, the fixing construction for fixing the discharge lamp is simplified, and thereby it is made possible to realize an improvement in workability. That is, although the resin cover was used to fix the discharge lamp, such a resin cover is made unnecessary, and hence the resulting construction can be simplified.

In addition, although the layer of air was defined between the metallic cover and the resin cover to thereby disturb the radiation of heat in the related art, such a layer of air is eliminated, and hence an improvement in heat radiating properties can be realized.

In the discharge lamp lighting device, the connecting member may have a reinforcement portion, and the reinforcement portion may have a positioning function to determine a mounting position of the discharge lamp.

According to the discharge lamp lighting device with the above-mentioned structure, the reinforcement portion has the function to position a discharge lamp, whereby the mounting work of the discharge lamp is facilitated, and thereby it is made possible to realize an improvement in assembling properties.

According to the discharge lamp lighting device of one or more embodiments of the present invention, because the connecting member is integrated with the substrate of the circuit module, the workability and the assembling properties can be improved and the heat radiating properties can be improved.

### BRIEF DESCRIPTION OF THE DRAWINGS

FIG. 1 is a sectional view of a vehicle headlamp 1 which includes a discharge lamp lighting device 10 illustrating one or more embodiments of the invention.

FIG. 2 is an exploded perspective view of the discharge lamp lighting device 10 shown in FIG. 1.

FIG. 3 is a partially enlarged perspective view showing a connecting member 20 shown in FIG. 2.

FIG. 4 is a vertical sectional view showing a fixed state of a discharge bulb 7 of the discharge lamp lighting device 10.

FIG. 5 is a partial perspective view showing another discharge lamp lighting device 30.

### DETAILED DESCRIPTION

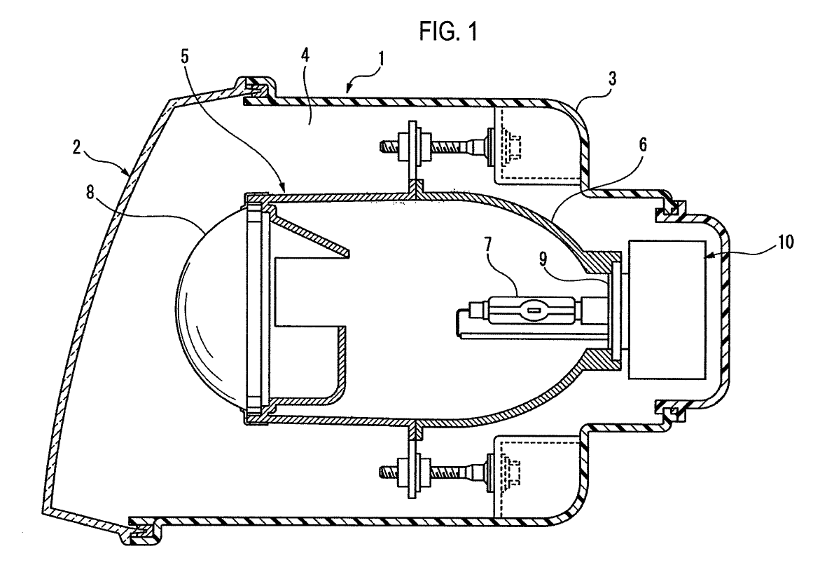

Hereinafter, embodiments of a discharge lamp lighting device according to the invention will be described by reference to FIGS. 1 to 5. In embodiments of the invention, numerous specific details are set forth in order to provide a more thorough understanding of the invention. However, it will be apparent to one of ordinary skill in the art that the invention may be practiced without these specific details. In other instances, well-known features have not been described in detail to avoid obscuring the invention.

As FIG. 1 shows, a vehicle headlamp 1 including a discharge lamp lighting device according to one or more embodiments of the invention has a lamp unit 5 which is accommodated in a lamp chamber 4, which is defined by a transparent cover 2 and a lamp body 3. The lamp unit 5 includes a reflector 6, a discharge bulb 7 and a projection lens 8. The discharge bulb 7 is mounted in a bulb socket 9, and this bulb socket 9 is fixed to a rear end portion of the reflector 6.

The discharge lamp lighting device 10 of one or more embodiments is a bulb-integrated ballast system and is fixed to the bulb socket 9. Thus, the discharge lamp lighting device 10 is disposed at the rear end portion of the reflector 6 in the lamp chamber 4.

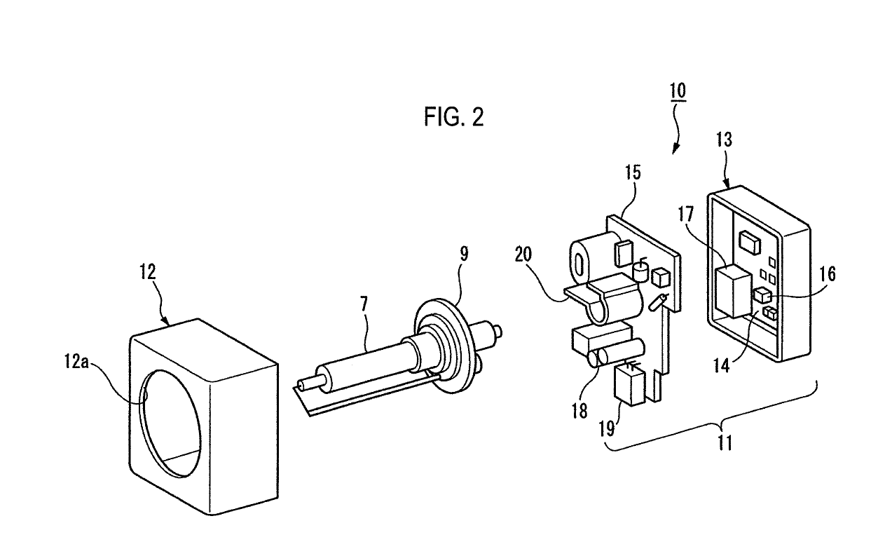

As FIG. 2 shows, the discharge lamp lighting device 10 includes a circuit module 11 for supplying a voltage to a discharge bulb so as to turn on the discharge lamp, and a metallic cover 12 and a case member 13, which together accommodate the circuit module 11. The circuit module 11 is made up of a first resin substrate 14, which is mounted in the case member 13, and a second resin substrate 15, which is mounted on the first substrate 14 with a predetermined space defined therebetween. The cover 12 has an insertion hole 12a which is formed in a front end face of the cover 12 so as to allow the discharge bulb 7 to be inserted therethrough. The cover 12 is placed over the case member 13 so as to cover the second substrate 15.

A power device 16 which is an electronic part generating heat and a coil 17 having a large heat capacity are mounted on the first substrate 14. In addition, an electrolytic condenser 18, which is an electronic part having low heat resistance, and a connector 19 for external connection are mounted on the second substrate 15. The electrolytic condenser 18 is spaced a predetermined distance apart from the power device 16, and therefore, the influence on the electrolytic condenser 18 by heat generated from the power device 16 is suppressed to a minimum level.

The circuit module 11 includes a converting module for converting a supply voltage supplied to the discharge bulb 7 by switching an input voltage by the power device 16, a high voltage generating module for generating a high voltage to be applied to the discharge bulb 7 when starting the turning-on of the discharge bulb 7, and a control circuit (not shown) for controlling electric power supplied to the discharge bulb 7 by switching on or off the power device 16.

In the discharge lamp lighting device 10 of one or more embodiments, by a connecting member 20, the bulb socket 9 is fixed on to the second substrate 15, and electrically connects to the circuit module 11. The connecting member 20 is formed integrally on the second substrate 15. This connecting member 20 may be formed integrally on the second substrate 15 when the second substrate 15 is formed or may be formed as a separate part for retrofit to the second substrate 15.

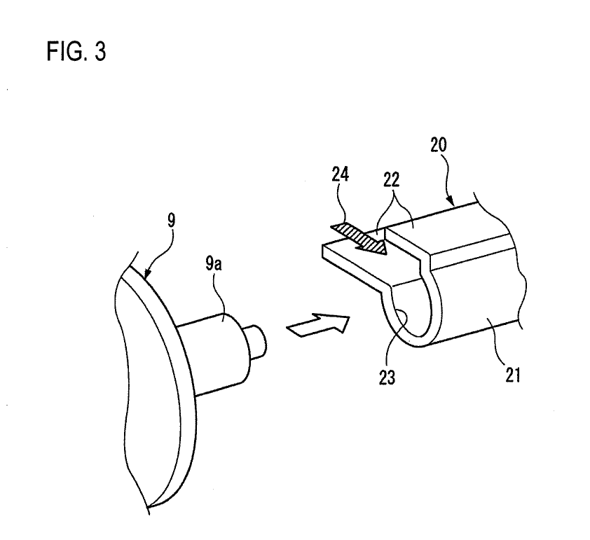

As FIG. 3 shows, the connecting member 20 includes a cylindrical portion 21 having a fitting hole 23 and a filling portion 22 which projects sideways. When mounting the bulb socket 9, a terminal portion 9a at a distal end of the bulb socket 9 is inserted into the fitting hole 23 in a direction indicated by an arrow. Thereafter, an adhesive 24 is filled in the fitting hole 23 from the filling portion 22. Through these operations, the bulb socket 9 is fixed on to the second substrate 15 strongly and rigidly by the connecting member 20. Then, placing the cover 12 over the case member 13 completes the assemblage of the discharge lamp lighting device 10.

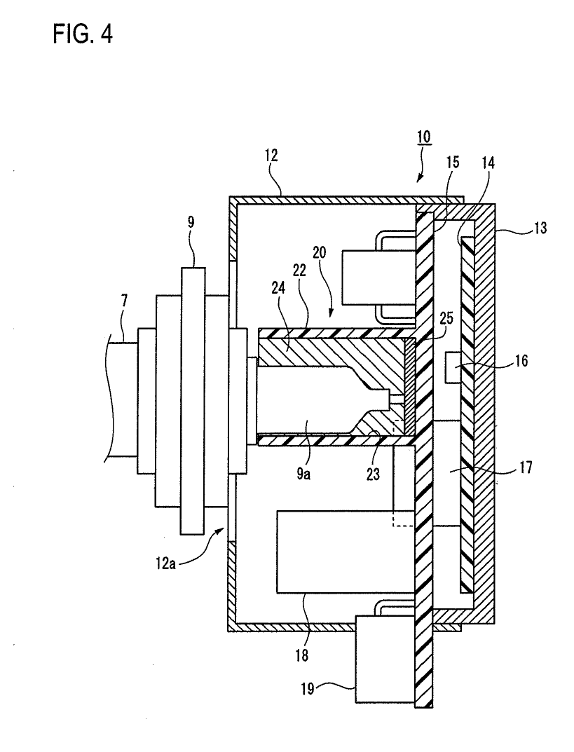

As FIG. 4 shows, the connecting member 20 is integrally formed in a predetermined position on the second substrate 15, which is disposed so that a predetermined space is held between the first substrate 14 in the case member 13 and itself. By the terminal portion 9a of the bulb socket 9, in which the discharge bulb 7 is mounted, being inserted into the fitting hole 23 in the connecting member 20 until the terminal portion 9a is butted against an energizing member 25, the terminal portion 9a is electrically connected with the circuit module 11. Thus, the bulb socket 9 is fixed on to the second substrate 15 by the terminal portion 9a being so inserted into the fitting hole 23, and the terminal portion 9a is fixed more strongly and rigidly by filling the adhesive 24 in the fitting hole 23.

According to the above-described discharge lamp lighting device 10 of one or more embodiments, the connecting member 20 is formed integrally with the second substrate 15 which makes up part of the circuit module 11. Therefore, the fixing construction for fixing the bulb socket 9 in which the discharge bulb 7 is mounted is simplified, and thereby it is made possible to realize an improvement in workability. That is, although the resin cover was used to fix the discharge bulb 7 in the related art, such a resin cover is made unnecessary in one or more embodiments of the invention, and hence the resulting construction can be simplified. In addition, although the layer of air was defined between the metallic cover 12 and the resin cover to thereby disturb the radiation of heat in the related art, such a layer of air is eliminated in one or more embodiments of the invention, and hence an improvement in heat radiating properties can be realized.

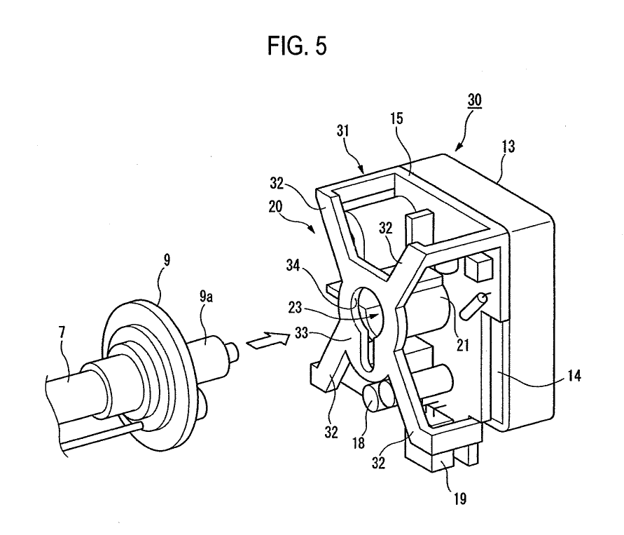

Next, a discharge lamp lighting device 30, which is a modified example made to the one or more embodiments described above, will be described by reference to FIG. 5. Like reference numerals will be given to like configurations to those of the discharge lamp lighting device 10, and the detailed description thereof will be omitted herein.

As FIG. 5 shows, in the discharge lamp lighting device 30, a reinforcement portion 31 for reinforcing a connecting member 20 is formed integrally on a second substrate 15 so as to be erected from four corners thereof. The reinforcement portion 31 has support portions 32 and an abutment portion 33. The abutment portion 33 is supported by the four support portions 32 from four directions. By being erected from the four corners of the second substrate 15, the support portions 32 also ensure rigidity required when a bulb socket 9 is mounted.

The abutment portion 33 is disposed on a front surface side of a fitting hole 23 in the connecting member 20. The abutment portion 33 has a guide hole 34. An axis of the guide hole 34 coincides with an axis of the fitting hole 23, and a terminal portion 9a of a bulb socket 9 is inserted through this guide hole 34 when the bulb socket 9 is mounted on the abutment portion 33. By being provided with the guide hole 34, the abutment portion 33 performs guiding and positioning functions when the bulb socket 9 is so mounted.

When the bulb socket 9 is mounted, the terminal portion 9a of the bulb socket 9 is inserted from the guide hole 34 in the abutment portion 33, whereby the terminal portion 9a is fitted into the fitting hole 23 continuously. As this occurs, the bulb socket 9 is held by the guide hole 34 as well as the fitting hole 23. That is, the bulb socket 9 is fixedly positioned by a cylindrical portion 21 having the fitting hole 23 and the reinforcement portion 31 having the guide hole 34. Thereafter, an adhesive 24 is filled in the fitting hole 23, whereby the bulb socket 9 is fixed more strongly and rigidly.

Thus, according to the discharge lamp lighting device 30, the connecting member 20 has the reinforcement portion 31, and this reinforcement portion 31 has the function to position a discharge lamp, whereby the mounting work of the discharge lamp is facilitated, thereby making it possible to realize an improvement in assembling properties.

While certain embodiments have been described, these embodiments have been presented by way of example only, and are not intended to limit the scope of the invention. Indeed, the novel device described herein may be embodied in a variety of other forms; furthermore, various omissions, substitutions, and changes in the form of the device, described herein may be made without departing from the sprit of the invention. The accompanying claims and their equivalents are intended to cover such forms or modifications as would fall within the scope and sprit of the invention. Accordingly, the scope of the invention should be limited only by the attached claims.

What is claimed is:

1. A discharge lamp lighting device comprising:
a discharge lamp;
a circuit module configured to supply a voltage to the discharge lamp so as to turn on the discharge lamp, the circuit module including a substrate;
a case member configured to accommodate the circuit module; and
a connecting member, in which the discharge lamp is mounted, configured to connect the discharge lamp to the circuit module,
wherein the connecting member is integrated with the substrate of the circuit module.

2. A discharge lamp lighting device as set forth in claim 1, wherein the connecting member has a reinforcement portion, and the reinforcement portion has a positioning function to determine a mounting position of the discharge lamp.
